(19) United States
(12) Patent Application Publication
(10) Pub. No.: US 2023/0408665 A1
(43) Pub. Date: Dec. 21, 2023

(54) METHOD FOR RADIO-BASED DISTANCE MEASUREMENT

(71) Applicant: LAMBDA:4 ENTWICKLUNGEN GMBH, Hamburg (DE)

(72) Inventor: Rönne REIMANN, Hamburg (DE)

(73) Assignee: LAMBDA:4 ENTWICKLUNGEN GMBH, Hamburg (DE)

(21) Appl. No.: 18/250,884

(22) PCT Filed: Nov. 3, 2021
(86) PCT No.: PCT/EP2021/080519

§ 371 Date: Jun. 23, 2023

(30) Foreign Application Priority Data
Nov. 4, 2020 (WO) PCT/EP2020/081016

(51) Int. Cl. G01S 11/08

(52) U.S. Cl. CPC G01S 11/08

(57) ABSTRACT

A method for radio-based distance measurement in which, between time-synchronised objects, particularly during phase-coherent frequency change, an aggregation of autocorrelation matrices determined for each transmission direction leads to improved fault immunity. This ensures that frequency hopping of a first object followed by frequency hopping of a second object occurs. The method determines between two time-synchronised objects and wherein a first and/or a second of the two objects emit signals at a plurality of frequencies and the distance between the first and the second object is determined. The method includes the formation of a first and a second autocorrelation matrix of the measurements and the aggregation of the first and the second autocorrelation matrix to form an aggregated autocorrelation matrix. The distance between the objects is calculated on the basis of the aggregated autocorrelation matrix.

### TECHNICAL FIELD

The invention relates to a method for radio-based distance measurement.

### BACKGROUND ART

Determining the distance between two objects based on the exchange of radio signals between the objects is known.

Synchronizing timers in two objects is also known, both via wired and wireless connections. For example, there is the NTP protocol. Within the scope of a Bluetooth connection, too, a synchronization is provided in which each object has a freely running 28-bit clock with a cycle of 3.2 kHz and each object ascertains its offset relative to a central clock, and corrects the offset on a regular basis. In this case, synchronization with an accuracy of approximately 125 ns is achieved. Improved time synchronization is also known, for example, from DE1 1 201 4004426T5 or “Synchronization in radio Sensor Networks Using Bluetooth,” Casas et al., Third International Workshop on Intelligent Solutions in Embedded Systems, 2005, ISBN: 3-90246303-1. This can be used for saving energy, for example, in that an object is kept ready to receive only in certain time slices, which are known to the other object, in order to send at corresponding times. Synchronization of the clocks is also still possible, at least with one-sided relatively strong interference on the radio channel, although the distance measurement becomes impossible or very inaccurate, or takes a very long time during such interference. Synchronization to a clock-cycle of a received signal at the receiver of the signal must be clearly differentiated from the accuracy of a time synchronization. In this case, there is no synchronization of two clocks to two objects, but rather the receiving object is set such that it is synchronized with the incoming signal. The signal time-of-flight does not play a role here, since for that it is irrelevant when the signal was sent and/or how long it took to be transmitted.

Calculating a distance from an autocorrelation matrix of a signal roundtrip time using mathematical methods, such as CAPON or MUSIC, is also known.

In this context, the phase shifts of the signal's outbound and return trips are summed, usually following an approximate correction of a 180° ambiguity problem. From the complex measured values created therefrom and from a determination of an amplitude, an autocorrelation matrix is then created, on the basis of which a distance is then calculated.

### SUMMARY OF THE INVENTION

In order to speed up the determination of the distance and/or to increase the accuracy of the determination of the distance between two objects and/or in the event of reception interference, it is desirable to carry out the distance determination in a manner less prone to error. The object of the present invention is to speed up the determination of the distance, to enable this with greater accuracy, and/or to enable or improve it even in the event of interference, in particular, one-sided and/or asymmetric interference, respectively, in the radio connection.

Surprisingly, the inventor has identified that, between time- and/or clock-cycle-synchronized objects, in particular during phase-coherent frequency change, an aggregation, particularly a summation, of the autocorrelation matrices determined for each transmission direction results in significantly improved interference resistance, particularly in the case of interference that is expressed differently at the two objects, which is generally the case. This also means that frequency hopping of an object can be carried out followed by frequency hopping of a second of the objects without compromising accuracy, instead of frequently changing the transmitter and receiver role. In the case of multiple objects that are to determine the distance between one another, every object can execute a frequency hopping successively and the ACMs of the measurements can be aggregated in pairs to the individual objects.

In particular, frequency hopping is understood as sending successively on different frequencies. This ensures a more rapid measurement, since the switching times of the transceivers can also be largely disregarded, and enables the distance to be determined even in the event of strong interference on the radio channel. It also enables a plurality of objects to determine the distances between one another rapidly and accurately, since the frequency hopping of each one of the objects can be used for distance determination by all of the other objects.

The problem is solved by a method for distance determination, in particular, based on phase times-of-flight or phase-based ranging (PBR), and particularly not based on pulse times-of-flight ToF between two or more objects, wherein the objects are and/or will be time- and/or clock-cycle-synchronized, particularly to 10 ns or better, particularly in the range between 10 ns and 100 ps, and wherein a first and/or second of the two objects emits signals at multiple frequencies, and the second and/or first of the two objects receives these signals, and the distance between the first and second object is determined therefrom as well as particularly from the knowledge of the time-points at which features of the signals were emitted, particularly at least one feature per frequency and/or per signal, i.e., of the time-point of switching to the frequency and/or of the beginning of transmitting the frequency, for example. In this context, at least two objects transmit successively, in particular, directly successively. Thus at first only the first object can transmit and the second or more objects can receive the signals of the first object, and then the second object can transmit and the first or more objects can receive the signals of the second object.

The method is characterized by the formation of a first autocorrelation matrix of the measurements, in particular a complex one, which is also to be understood to include corrected measurements on the signals of the first object received at the second object, for example for compensating the time drift between the timers of the two objects, and the formation of a second autocorrelation matrix of the measurements, in particular a complex one, for example, which is also to be understood to include corrected measurements on the signals of the second object received at the first object, for example for compensating the time drift between the timers of the two objects. For this purpose, generally a measurement value vector of the measurements is formed in each case as a complex vector and its autocorrelation matrix is calculated. In particular, these are measurements of only the simple distance between the objects. The measurement value vector of the signals of the first object received at the second object thus contains only complex numbers from the measurements of the signals of the first object received at the second object, and not an aggregation of measurements of the outbound and return path, as is usual, conversely, in the prior art.

The method is further characterized by aggregating the first and second autocorrelation matrix into an aggregated autocorrelation matrix, in particular, a complex autocorrelation matrix, in particular by sum formation, as well as calculating the distance between the first and second object on the basis of the aggregated autocorrelation matrix.

The problem is also solved by a use of an autocorrelation matrix that is aggregated, particularly summed, from at least two autocorrelation matrices for determining a distance between two objects, wherein each of the objects emits signals at multiple frequencies, in particular, executes a frequency hopping, and the respectively other object receives these signals, and from the measurements of phase and amplitude, or phase and power, at least one complex vector of the reception at each object is created, i.e., at least one first vector of that which is received at the first object and at least one second vector from that which is received at the second object, and one of the at least two autocorrelation matrices is created in each case from the at least one first and second complex vector.

Especially advantageously, the first and second object change between at least two of the multiple frequencies phase-coherently and/or such that the phase jump is known and/or determined upon change of the frequencies during transmitting and/or upon receiving, and in particular, the phases measured upon reception are corrected by this phase jump or these phase jumps, in particular, before formation of the autocorrelation matrix and/or the aggregated autocorrelation matrix.

Thus, especially advantageously, the knowledge of the frequency jump upon the change in frequency is used to enable a simple measurement or calculation, for example, for correcting the measurement of the phases. At a phase jump of zero, this knowledge is also used, in particular, in that the measurement of the phases is used directly to calculate a distance, i.e., it is corrected only by zero.

Advantageously, signal components of the first and/or second object at frequencies with less than 40%, or at least signals with less than 20%, particularly less than 40%, of the mean energy of the signals, and/or signals with more than 140%, particularly more than 120%, of the mean energy remain unconsidered, i.e., are left out in the distance determination, and therefore particularly in the formation of measurement value vectors and autocorrelation matrices. In this manner, the influence of interference and inaccuracies of the electronic assemblies used can be reduced further.

Preferably a plurality of objects execute the method jointly, wherein in each case the autocorrelation matrices of the signal exchange of a pair are formed, and therefrom the distance in the pair is calculated, wherein the autocorrelation matrices of a reception are used in more than one pair. This saves energy and time.

For forming an autocorrelation matrix of the reception at an object, it is advantageous for the autocorrelation matrices of the reception at the object via different antenna paths to be aggregated, particularly summed.

Distance and distance are used synonymously to refer to the distance between two objects. Moreover, the distance or the distance calculation in virtual space is discussed, in which it is not the distance between two real objects that is determined, but rather a distance in a virtual space, for example, between an autocorrelation matrix and another matrix. In the latter case, however, reference is then made to virtual space.

Features of the signal are to be understood particularly as changes of the signal, such as change in amplitude, polarization, the emitting antenna (change between antennas), frequency, and/or phase. However, aggregated groups of features can also be used, which augment the robustness of the method in some situations. For example, modulated packets or synchronization characters can be used as groups of features.

In particular, the objects use approximately identical frequencies in their frequency hopping, wherein the sequence of these frequencies in the frequency hopping is not decisive. The frequencies are approximately identical particularly when they differ by less than 5%, particularly less than 1% of the lower frequency, and/or less than 17 MHz, particularly less than 10 MHz, particularly less than 9 MHz, particularly less than 2 MHz. For example, Object A can thus use the frequencies FA1, FA2 to FAn, and Object B can use the frequencies FB1, FB2 to FBn, wherein 95% FAx<=FBx<=105% FAx, with x from 1 to n.

In particular, a frequency hopping is understood as transmitting successively on different frequencies.

The frequencies, particularly those of the frequency hopping, lie particularly in a span from 25 to 100 MHz, in particular they completely span such a span. Particularly the frequencies, particularly of the frequency hopping, lie in the range from 2 to 6 GHz. A spacing in the range from 0.1 to 10 MHz, particularly in the range from 0.5 to 10 MHz, lies particularly between adjacent but not necessarily consecutive frequencies, particularly of the frequency hopping.

Based on the knowledge of the phase jump upon each frequency change on the transmitter side and on the receiver side, as well as the time drift, in particular the phase shifts are determined on the basis of the distance (or phase time-of-flight) for each of the frequencies of the frequency hopping, and with the respectively received amplitude, are merged into a complex number. The measurement values are arranged in a vector and an autocorrelation matrix is formed from this vector. This occurs in each case for the signals received at an object. The autocorrelation matrices formed thereby, one per each object, are then summed in pairs to determine, from this aggregated autocorrelation matrix of a pair of objects, the distance between these objects. The vectors are formed, in particular, such that for the pairs between which the distance is determined, the rows or columns of the vector are in each case assigned to a frequency and this assignment is done identically for creating the vectors of each of the pairs. In the case of multiple reception paths, such a vector can be created for each of the reception paths of a reception, and therefrom in each case an autocorrelation matrix can be determined, which are then summed for an object.

Especially advantageously, the first and/or the second object changes between at least two of the multiple frequencies phase-coherently, or a phase jump arising upon switching at the switching object is measured or switched such that the phase jump is known and is considered in the calculation. The change is realized, in particular, by switching at least one PLL. An even robuster and simpler distance measurement can be implemented thereby, and additional advantages in the use of the signals can be realized in that evaluations based thereupon are simplified. In particular, the correction is conducted such that the measured phase is corrected by the phase jump.

Phase-coherent switching or changing between two frequencies is understood to mean, particularly, that the phase after the switching is known relative to the phase position before the switching. This is the case when the change of phase when switching is zero, or is equivalent to a previously known or ascertainable value. In this manner, further measurements of the phase at the transmitter can be avoided, and the calculation can be simplified, particularly when frequencies are switched between without phase change. It is advantageous not only for the transmitting object to switch in a phase-coherent manner, but also for the receiving object to do so, in particular a PLL is switched in a phase-coherent manner in each object.

Alternatively, switching can be preferably phase-coherent, but also not, and the change in phase can be determined locally, i.e., particularly at the transmitter before the transmission and/or at the receiver relative to the PLL of the receiver, and this change can be corrected in the calculation.

For example, when the point in time of the phase-coherent change or of the change with measured phase jump at the transmitting object is known, and when the change in the received signal is determined at the received object, the time between transmitting and receiving the change is determined, which time represents the signal time-of-flight (ToF), and the phase shift is also determined, which results solely from the signal flight. The distance can be directly determined from the signal time-of-flight using the speed of light. This is likewise possible by using the phase shift, however modulo the wavelength. The ambiguity accompanying the phase-based measurement can be reduced by using multiple frequencies. A particularly accurate and robust distance measurement can be realized by combining the signal time-of-flight measurements (pulse time-of-flight, ToF) and phase-based measurements (phase-based ranging, PBR).

Phase-coherent switching between two frequencies is understood to mean, particularly, that the time-point of the switching is determined exactly or is measured, and the phase after the switching is known relative to the phase situation before the switching. This is the case when the change of phase when switching is zero, or is equivalent to a previously known value.

The signals are radio signals, in particular.

Moreover, surprisingly, it was established that the distances obtained from the one-sided distance measurement or the distance measurement according to the invention described here, are dependent upon the frequency used for the distance determination when standard commercial transceivers are used, such as the somewhat older cc2500 or the current cc26xx by Texas Instruments or the Kw35/36/37/38 by NXP or the DA1469x by Dialog. In this context, inaccuracies in the transceivers also seem to result in calculated distances that are less than the actual distance, but only with those frequencies whose transmission channel is highly attenuated, such that these can be eliminated from the calculation without issue.

Therefore, it is advantageous for the distance determination not to use signal components of the object whose signals are used for the distance determination, for the distance determination in certain cases, namely to not use such components that lie above an upper power limit and/or to not use such components that lie below a lower power limit. These limits can be predetermined, or can be determined based on the received signals, and particularly can be above or below the mean received power, and can be particularly at least 20% above the mean received power (upper power limit) and/or at least 20% above the mean received power (lower power limit).

Preferably, not taken into account are signal components at frequencies received with less than 40%, or at least signals received with less than 20%, particularly less than 40%, of the mean energy of the signals, and/or signals received with greater than 140%, particularly with greater than 120% of the mean energy.

Advantageously, the lower power limit lies in the range from 5 to 50% of the mean power of the received signals, and/or the upper lower limit lies in the range from 120 to 200% of the mean power of the received signals.

In another embodiment, of the signals, particularly those selected in the decision, the x % of the signals with the smallest received amplitude are sorted out and not used, and/or the y % of the signals with the greatest received amplitude are sorted out and not used. It has been shown to be particularly advantageous when the sum of x and y is not less than 10 and/or does not exceed 75, and/or x lies in the range from 10 to 75, and/or y lies in the range from 20 to 50. In most situations, high accuracy and reliable distance determination can be obtained with these values.

Advantageously, the second or the first object, in particular either the second or the first object, does not transmit any signals for distance determination, and/or the second or the first object, particularly exclusive, or, only transmits signals for time- and/or clock-cycle synchronization. This saves energy and method time.

Preferably the first and/or second, or each of the two objects, sends the signals at multiple frequencies successively and/or consecutively, in particular directly consecutively. In particular, when sending is taking place by the first and second object, all signals of the first or of the second object are sent first, then those of the other. If one is working with multiple objects, in particular they all send a frequency hopping successively, particularly one frequency hopping each. Influences of environmental or distance changes, and of movements of one or both objects, can be thus reduced.

Advantageously, at no time does the bandwidth of the signals exceed 50 MHz, particularly 25 MHz. Consequently energy can be saved, interference with other processes can be prevented, and simple components can be used compared to broadband methods.

Preferably, a time- and/or clock-cycle synchronization and/or correction is carried out between the two objects before, after and/or while the method is carried out. This augments the accuracy of the method. Preferably, a drift of the clock of the first and/or second object, or a difference in the drift of the clock of the first and of the second object, is also determined and considered in the distance determination. This augments the accuracy of the method.

Advantageously, the method is carried out such that the frequency spacing between two consecutive frequencies of the multiple frequencies is at least 0.1 MHz and/or a maximum of 10 MHz, and/or the multiple frequencies are at least five frequencies and/or a maximum of 200 frequencies, and/or wherein the multiple frequencies span a frequency band of at least two MHz and/or a maximum of 100 MHz. Thus can a balanced measure be found between bandwidth requirement, which imposes requirements for available frequencies and hardware, and accuracy.

Preferably, the method is carried out such that the accuracy of the distance determination lies in the range from 0.3 m to 3 m, in particular at least for distances in the range from 0 to 50 m. The advantages of the invention are brought to bear particularly in these ranges.

It is preferable to apply high-resolution methods, such MUSIC or CAPON, which can calculate a distance on the basis of an autocorrelation matrix, particularly a complex one. Advantageously, for every signal that is to remain unconsidered which is received at the second and/or first object, a value proportional to its amplitude and a phase value are determined, and particularly therefrom, in each case, if applicable after correction of a phase jump during the frequency change or of a determinable phase measurement error due to drift of the timer or frequency encoders, a complex number is determined from which at least one measurement value vector is constructed, from which in each case an autocorrelation matrix is created. In particular, the autocorrelation matrices of an object, particularly those of the receiver of a frequency hopping of another object, are summed In particular, the, potentially summed, autocorrelation matrix for the reception of the frequency hopping of object X at object Y, is aggregated with the, potentially summed, autocorrelation matrix for the reception of the frequency hopping of object Y at object X, particularly is summed, and this aggregated autocorrelation matrix is used for the distance determination between object X and Y.

In particular, the aggregated autocorrelation matrix is used to determine the distance by means of known methods, for example MUSIC, CAPON, comparison with, distance calculation in virtual space to, and/or projection onto, the emitting and/or receiving characteristics. Advantageously, the distance calculation occurs in virtual space by means of eigenvalue, or eigenvector determination, of the at least one autocorrelation matrix and/or Fourier transformation of the complex values.

Such approaches are advantageous for achieving a reliable determination, particularly with multipath signal propagation.

Advantageously, a mean value is determined from multiple distance determinations, and/or the measurements are averaged in order to determine a distance value.

When a position finding is striven for, it is advantageous to carry out the method according to the invention between a plurality of pairs of objects, wherein in particular one object of each pair is an object that is involved in all pairs, and wherein the ascertained distances of the pairs are used to carry out a mapping and/or position determination of at least one of the objects. It is then advantageous, in particular, to make these pair-wise measurements simultaneously, wherein the sending does not take place simultaneously, but rather all objects carry out at least one frequency hopping, in particular, directly consecutively.

The problem is also solved by one or two objects, each of which is configured with transmission and receiving means, and a controller, configured for carrying out the method according to the invention.

Advantageously, the objects are parts of a data transmission system, particularly a Bluetooth, WLAN, or wireless, data transmission system. Preferably, the signals are signals of the data transmission system, particularly of a data transmission standard, for example a wireless standard, WLAN, or Bluetooth, that is used for data transmission according to the data transmission standard.

Advantageously, the signals are transmitted over multiple antenna paths, particularly at least three, particularly with multiple antennas, particularly successively, sent at the sending object and/or received at the receiving object with multiple antennas.

The calculation is done as follows, for example: in the averaging of the measured distances, the measurements of the received signals with less than, e.g., 40% of the mean energy of the received signals, are ignored. Thus measurements on frequencies with strongly attenuated transmission channel are disregarded.

### BRIEF DESCRIPTION OF THE DRAWINGS

FIG. 1 shows schematically an exemplary possible method sequence in accordance with the present disclosure.

### DETAILED DESCRIPTION

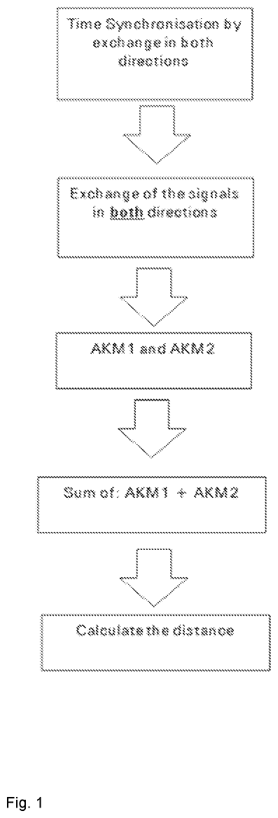

FIG. 1 shows a possible method sequence, purely schematically and not limiting and only as an example. First, a time synchronization between two objects occurs and a setting of the oscillators on the two objects. Both objects then execute a frequency hopping. This occurs consecutively while the other object respectively receives the transmitted signals. Based on the knowledge of the phase jump upon each frequency change on the transmitter side and on the receiver side, as well as the time drift, the phase shifts are determined on the basis of the distance (or phase time-of-flight) for each of the frequencies of the frequency hopping, and with the respectively received amplitude, are aggregated into a complex number. The measurement values are arranged in a vector and an autocorrelation matrix is formed from this vector. This occurs in each case for the signals received at an object. The autocorrelation matrices formed thereby, one per each object, are then summed in pairs to determine, from this aggregated autocorrelation matrix of a pair of objects, the distance between these objects.

1. A method for determining a distance between at least two objects, wherein the at least two objects are or will be time- or clock-cycle-synchronized, and wherein a first object and a second object of the at least two objects emit signals at multiple frequencies, and the second object and the first object of the at least two objects receive the signals of the respectively other of the first object and the second object, and the distance between the first object and the second object is determined therefrom, wherein the method includes forming a first autocorrelation matrix of measurements on the signals of the first object received at the second object, and forming a second autocorrelation matrix of measurements on the signals of the second object received at the first object, as well as aggregating the first autocorrelation matrix and the second autocorrelation matrix into an aggregated autocorrelation matrix and in that the distance between the first object and the second object is calculated on the basis of the aggregated autocorrelation matrix.

2. A use of an autocorrelation matrix aggregated from at least two autocorrelation matrices for determining a distance between two objects, wherein each of the two objects emits signals at multiple frequencies and the respectively other of the two objects receives the emitted signals, and at least one complex vector of the reception of the emitted signals is created from measurements of phase and amplitude, or phase and power, and one of the at least two autocorrelation matrices is created from the at least one complex vector of each object of the two objects.

3. The method according to claim 1, wherein the first object or the second object, or both, change(s) between at least two of the multiple frequencies phase-coherently or change(s) such that a phase jump is known or determined upon change of the at least two of the multiple frequencies during transmitting.

4. The method according to claim 1, wherein for the distance determination, signal components of the first object or the second object, or both, at frequencies with less than 40%, or at least signals with less than 20%, or signals with more than 140% of the mean energy remain unconsidered.

5. The method according to claim 1, wherein a plurality of objects execute the method jointly, and in each case the autocorrelation matrices of the signal exchange of a pair of objects is formed, and therefrom the distance in the pair of objects is calculated, wherein the autocorrelation matrices of a reception are used in more than one pair of objects.

6. The method according to claim 1, wherein the first object or the second object of the at least two objects, or both, emits the signals at the multiple frequencies successively or consecutively, or wherein at no time the bandwidth of the signals exceeds 50 MHz.

7. The method according to claim 1, wherein at least one time- or clock-cycle synchronization or correction is carried out between the at least two objects before, after or while the method is carried out.

8. The method according to claim 1, wherein a frequency spacing between two consecutive frequencies of the multiple frequencies is at least 0.1 MHz or a maximum of 10 MHz, and additionally or alternatively the multiple frequencies are at least five frequencies or a maximum of two hundred frequencies.

9. The method according to claim 1, wherein accuracy of the distance determination lies in a range from 0.3 m to 3 m.

10. The method according to claim 1, wherein the distance determination is based on ascertaining a signal time-of-flight from the first object to the second object, or from the second object to the first object, or wherein the distance determination is based on ascertaining a phase shift of the signals from the first object to the second object, or from the second object to the first object, or is based on both ascertaining the signal time-of-flight and ascertaining the phase shift.

11. The method according to claim 1, wherein a time drift of at least one of the at least two objects is determined or corrected or is considered in the calculation of the distance.

12. The method according to claim 1, wherein a mean value is determined from multiple spacing determinations.

13. The method according to claim 1, wherein signals received at the second object or the first object with a received power below a predetermined or calculated lower power limit, are not taken into consideration for the distance determination.

14. The method according to claim 1, carried out between a plurality of pairs of objects, and wherein ascertained distances of pairs of objects of the plurality of pairs of objects are used to carry out a mapping or position determination.

15. An object or an object pair, configured for carrying out the method according to claim 1.

16. The method according to claim 3, wherein the phases measured upon reception are corrected by the phase jump before formation of the autocorrelation matrix or the aggregated autocorrelation matrix.

17. The method according to claim 1, wherein for forming the autocorrelation matrix of the reception of signals at one of the first object and the second object, the autocorrelation matrices of the reception at the one of the first object and the second object via different antenna paths are aggregated.

18. The method according to claim 1, wherein at no time does the bandwidth of the signals exceed 50 MHz.

19. The method according to claim 1, wherein signals received at the second object or the first object with a power above a predetermined or calculated upper power limit, are not taken into consideration for the distance determination.

20. The method according to claim 14, wherein one object of each pair is an object that is involved in all pairs.
